(19) United States
(12) Patent Application Publication
(10) Pub. No.: US 2017/0030717 A1
(43) Pub. Date: Feb. 2, 2017

(54) ESTIMATING APPARATUS, TRAVEL DIRECTION ESTIMATING METHOD, AND NON-TRANSITORY COMPUTER READABLE STORAGE MEDIUM

(71) Applicant: YAHOO JAPAN CORPORATION, Tokyo (JP)

(72) Inventor: Munehiro AZAMI, Tokyo (JP)

(73) Assignee: YAHOO JAPAN CORPORATION, Tokyo (JP)

(21) Appl. No.: 15/193,727

(22) Filed: Jun. 27, 2016

(30) Foreign Application Priority Data
Jun. 30, 2015 (JP) 2015-132015

(51) Int. Cl. G01C 21/16; G01S 19/49

(52) U.S. Cl. CPC G01C 21/16; G01S 19/49

(57) ABSTRACT

According to one aspect of an embodiment, an estimating apparatus includes a detector that detects accelerations. The estimating apparatus includes an identifying unit that identifies a gravity direction using an average of the accelerations that the detector detects in a certain state. The estimating apparatus includes an estimating unit that estimates a travel direction based on the gravity direction that the identifying unit identifies from the accelerations that the detector detects.

### CROSS-REFERENCE TO RELATED APPLICATION

The present application claims priority to and incorporates by reference the entire contents of Japanese Patent Application No. 2015-132015 filed in Japan on Jun. 30, 2015.

### BACKGROUND OF THE INVENTION

1. Field of the Invention

The present invention relates to an estimating apparatus, a travel direction estimating method, and a non-transitory computer readable storage medium.

2. Description of the Related Art

A technique of car navigation (hereinafter, also referred to as “guidance”) that guides a vehicle in which a user rides to a destination using a portable terminal apparatus such as a smartphone has conventionally been known. The terminal apparatus that performs such guidance identifies a current position of the vehicle using a satellite positioning system such as the Global Positioning System (GPS) and displays a screen indicating a map and a guidance route and the identified current position in a superimposed manner.

The terminal apparatus cannot display the current position in sites in which signals from satellites are difficult to be received such as the inside of a tunnel. The same problem is common to positioning in general using external signals (radio waves from mobile phone (cellular) base stations, wireless LAN radio waves, or the like), not limited to the GPS. Given this situation, a technique is considered that estimates the current position of the vehicle based on a travel direction and a speed of the vehicle. A technique is developed that fixes an apparatus including an accelerometer to the inside of a vehicle in a certain attitude and identifies an travel direction of the vehicle from an acceleration that the apparatus detects, for example. Conventional technologies are described in Japanese Patent Application Laid-open No. 11-248455, for example.

However, the terminal apparatus such as a smartphone varies in its installation attitude in the vehicle every time in accordance with the type of the vehicle in which the user rides, a use situation of a holder that holds the terminal apparatus, or the like and thereby causes a problem in that a direction in which the vehicle has traveled cannot be estimated easily.

The terminal apparatus includes an accelerometer that detects an axial acceleration based on the terminal apparatus, for example, and transforms the direction of the detected acceleration into a direction based on the travel direction of the vehicle based on the installation attitude of the terminal apparatus. The terminal apparatus identifies the travel direction and the speed of the vehicle using the acceleration with its direction transformed and identifies the current position of the vehicle from the identified travel direction and speed. However, the terminal apparatus cannot transform the direction of the acceleration and cannot identify the travel direction of the vehicle when the installation attitude is unclear.

### SUMMARY OF THE INVENTION

It is an object of the present invention to at least partially solve the problems in the conventional technology.

According to one aspect of an embodiment, an estimating apparatus includes a detector that detects accelerations. The estimating apparatus includes an identifying unit that identifies a gravity direction using an average of the accelerations that the detector detects in a certain state. The estimating apparatus includes an estimating unit that estimates a travel direction based on the gravity direction that the identifying unit identifies from the accelerations that the detector detects.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram having sections (A)-(G) for illustrating an example of effects that a terminal apparatus according to an embodiment exhibits;

FIG. 2 is a diagram of an example of a functional configuration that the terminal apparatus according to the embodiment has;

FIG. 3 is a flowchart of an example of a procedure of guidance processing that the terminal apparatus according to the embodiment executes;

FIG. 4 is a flowchart of an example of a procedure of estimation processing that the terminal apparatus according to the embodiment executes;

FIG. 5 is a diagram of an example of an acceleration occurring when a vehicle travels; and

FIG. 6 is a diagram of an example of processing in which the terminal apparatus according to the embodiment calculates a speed of a vehicle.

### DETAILED DESCRIPTION OF THE PREFERRED EMBODIMENTS

The following describes forms (hereinafter, referred to as “embodiments”) to implement an estimating apparatus, a travel direction estimating method, and a non-transitory computer readable storage medium having stored therein a travel direction estimating program according to the present application in detail with reference to the accompanying drawings. These embodiments do not limit the estimating apparatus, the travel direction estimating method, and the non-transitory computer readable storage medium according to the present application. In the following embodiments, the same parts and processing are attached with the same symbols, and a duplicate description will be omitted.

Although an example of car navigation that guides a vehicle in which a user rides to a destination will be described as processing that the estimation apparatus executes in the following description, embodiments are not limited thereto. Also when a user is walking or using a means of transportation other than the vehicle such as a train, the estimating apparatus may execute processing described below and execute processing to guide the user to the destination, for example.

### 1. Outline of Effects

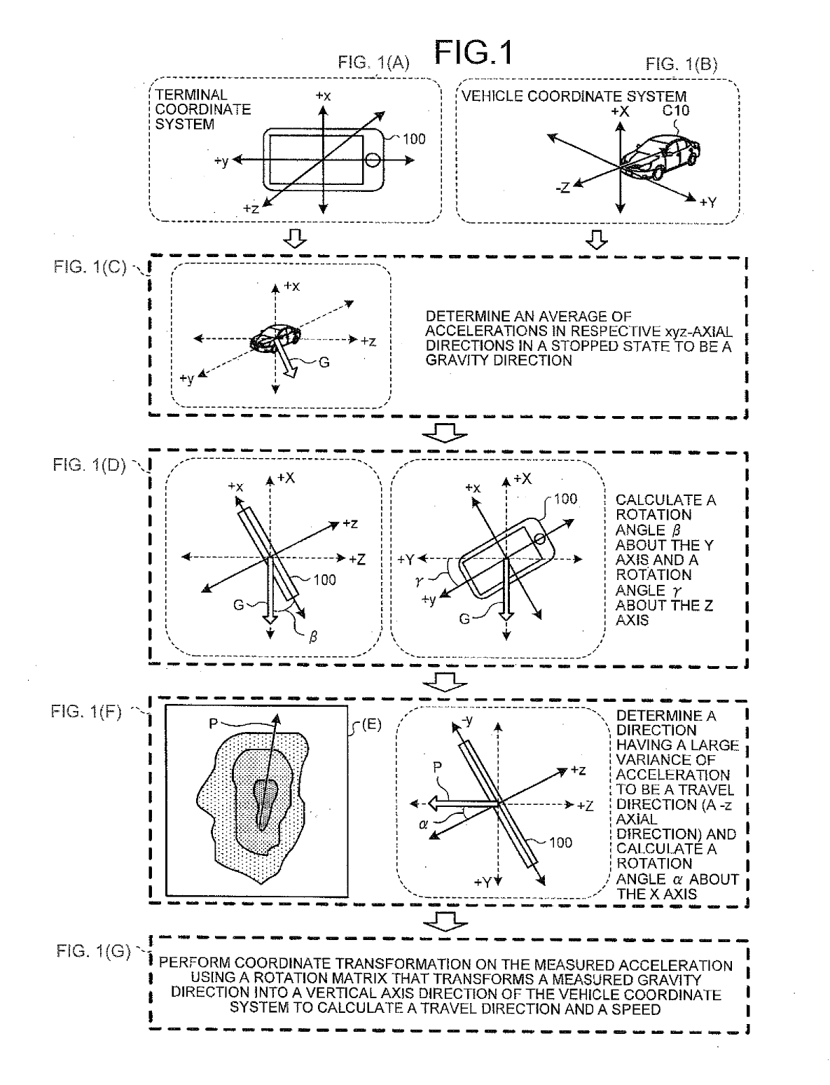

First, the following describes a concept of effects that a terminal apparatus 100 as an example of the estimation apparatus exhibits with reference to FIG. 1. FIGS. 1A to 1G are diagrams for illustrating an example of effects that a terminal apparatus according to an embodiment exhibits. The terminal apparatus 100 is a terminal apparatus such as a mobile terminal such as a smartphone, a tablet terminal, or a personal digital assistant (PDA) or a notebook personal computer (PC) and is a terminal apparatus that can communicate with a given server via a network N such as a mobile communication network or a wireless local area network (LAN), for example.

The terminal apparatus 100 has a function of car navigation that guides the vehicle in which the user rides to the destination. Upon reception of input of the destination from the user, the terminal apparatus 100 acquires route information for guiding the user to the destination from a server (omitted to be illustrated) or the like, for example. The route information includes routes to the destination available by the vehicle, information on expressways contained in the routes, information on congestion on the routes, facilities as guides for the guidance, information on maps to be displayed on a screen, and data on voices and images such as maps to be output during the guidance, for example.

The terminal apparatus 100 has a positioning function that identifies the position (hereinafter, referred to as a “current position”) of the terminal apparatus 100 at certain time intervals using a satellite positioning system such as the Global Positioning System (GPS). The terminal apparatus 100 displays the images such as maps contained in the route information on a liquid crystal screen or an electroluminescence or light emitting diode (LED) screen (hereinafter, simply referred to as a “screen”) and displays the identified current position every time on a map. The terminal apparatus 100 displays left turns, right turns, changes of lanes to be used, an estimated arrival time to the destination, and the like or outputs them by voice from a speaker or the like of the terminal apparatus 100 or the vehicle in accordance with the identified current position.

The satellite positioning system receives signals transmitted from a plurality of satellites and identifies the current position of the terminal apparatus 100 using the received signals. For this reason, the terminal apparatus 100 cannot identify the current position when the signals transmitted from the satellites cannot appropriately be received such as the inside of a tunnel or a place surrounded by buildings. An application or the like that causes the terminal apparatus 100 to implement the guidance does not have any function that acquires information on speed, travel direction, and the like from the vehicle. Given this situation, a method is considered that installs an acceleration sensor that measures an acceleration in the terminal apparatus 100 and estimates the position of the terminal apparatus 100 based on the acceleration that the acceleration sensor measures.

As illustrated in section 1A of FIG. 1, with a short-side direction of a screen as an x axis, with a long-side direction of the screen as a y axis, and with a direction perpendicular to the screen as a z axis, the terminal apparatus 100 measures accelerations in the respective xyz-axis directions, for example. The terminal apparatus 100 measures an acceleration in a terminal coordinate system that, when the screen is designated as a front face, designates the front face side as a +z-axis direction, designates the back face side as a −z-axis direction and, when the terminal apparatus 100 is used, designates the upper side of the screen as a +x-axis direction, designates the lower side of the screen as a −x-axis direction, designates the left side of the screen as a +y-axis direction, and designates the right side of the screen as a −y-axis direction, for example.

As illustrated in section 1B of FIG. 1, a travel direction and a speed of a vehicle C10 that the user uses are represented by a vehicle coordinate system that designates a direction in which the vehicle travels as a Z axis and, on a plane perpendicular to the Z axis, designates a direction in which the vehicle while traveling turns left or right as a Y-axis direction, and designates an up-and-down direction of the vehicle as an X-axis direction. The travel direction and the speed of the vehicle C10 are represented by a vehicle coordinate system that designates the upper direction of the vehicle as a +X-axis direction, designates the lower direction (that is, the ground side) of the vehicle as a −X-axis direction, designates a direction turning left as a +Y-axis direction, designates a direction turning right as a −Y-axis direction, designates the rear direction of the vehicle as a +Z-axis direction, and designates the front direction of the vehicle as a −Z-axis direction, for example.

From the foregoing, the terminal apparatus 100 transforms the acceleration measured in the terminal coordinate system into the acceleration measured in the vehicle coordinate system and, using the transformed acceleration, measures the travel direction and the speed of the vehicle. However, the terminal apparatus 100 varies in its installation attitude every time in accordance with whether the user on a passenger seat holds it with a hand or it is held by a holder, an angle at which the holder holds the terminal apparatus 100, or the type of the vehicle in which the user rides, for example. For this reason, when the installation attitude is unclear, even when the acceleration is measured, the acceleration measured in the terminal coordinate system cannot be transformed into the acceleration measured in the vehicle coordinate system.

Given this situation, the terminal apparatus 100 performs estimation processing. First, the terminal apparatus 100 includes an acceleration sensor that detects accelerations on the terminal apparatus 100. The terminal apparatus 100 identifies a gravity direction in the vehicle coordinate system using an average of the accelerations detected in a certain state. The terminal apparatus 100 estimates a travel direction based on the identified gravity direction, that is, the travel direction of the vehicle C10 in the vehicle coordinate system from the accelerations that the acceleration sensor detects.

The following describes examples of a functional configuration and effects of the terminal apparatus 100 that implements the above estimation processing with reference to the drawing.

### 2. Example of Functional Configuration

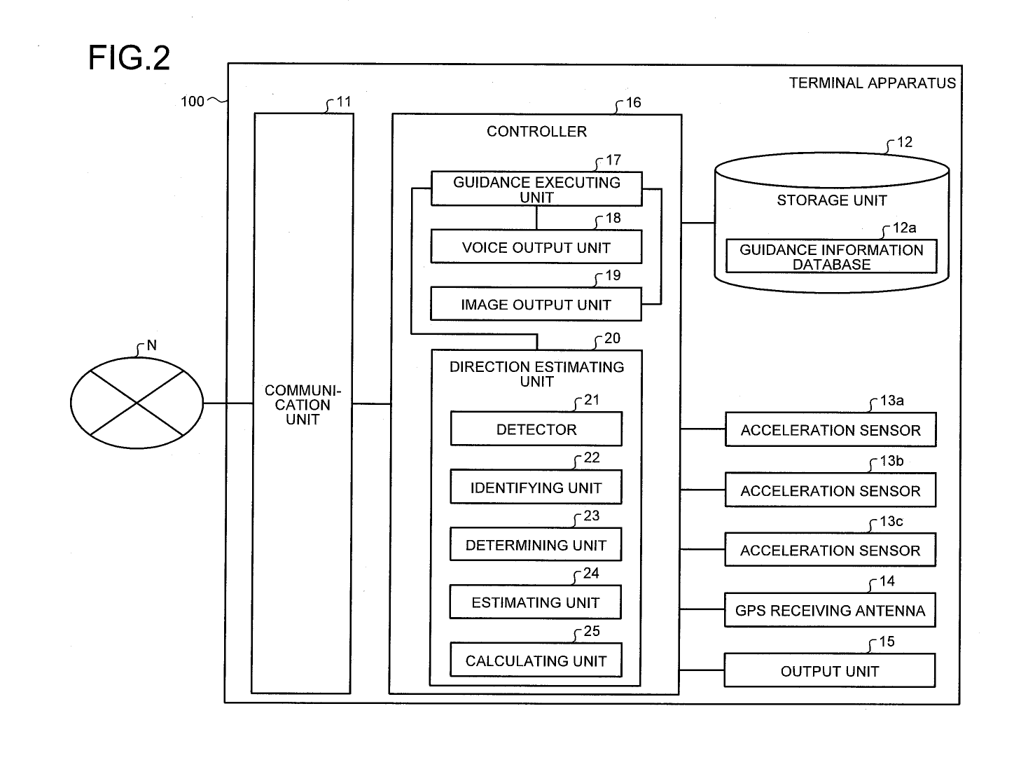

FIG. 2 is a diagram of an example of a functional configuration that the terminal apparatus according to the embodiment has. As illustrated in FIG. 2, the terminal apparatus 100 includes a communication unit 11, a storage unit 12, a plurality of acceleration sensors 13a to 13c (hereinafter, may collectively be referred to as an “acceleration sensor 13”), a GPS receiving antenna 14, an output unit 15, and a controller 16. The communication unit 11 is implemented by Network Interface Card (NIC), for example. The communication unit 11 is connected to the network N in a wired or wireless manner and performs transmission and reception of information between the terminal apparatus 100 and a distribution server that distributes the route information indicating a route to the destination upon reception of the destination from the terminal apparatus 100.

The storage unit 12 is implemented by a semiconductor memory element such as a random access memory (RAM) or a flash memory or a storage apparatus such as a hard disk or an optical disc, for example. The storage unit 12 includes a guidance information database 12a as various kinds of data used to execute the guidance. The guidance information database 12a stores therein the route information to the destination received from the server (omitted to be illustrated) or the like, for example.

The acceleration sensor 13 measures the magnitude and the direction of accelerations on the terminal apparatus 100 at certain time intervals (e.g., 5 ms). The acceleration sensor 13a measures an acceleration in the x-axis direction in the terminal coordinate system, for example. The acceleration sensor 13b measures an acceleration in the y-axis direction in the terminal coordinate system. The acceleration sensor 13c measures an acceleration in the z-axis direction in the terminal coordinate system. In other words, the terminal apparatus 100 determines the accelerations that the respective acceleration sensors 13a to 13c measure to be the accelerations in the respective axis directions in the terminal coordinate system and can thereby acquire a vector indicating the direction and the magnitude of the accelerations on the terminal apparatus 100.

The GPS receiving antenna 14 is an antenna for receiving signals for use in the satellite positioning system such as the GPS from the satellites. The output unit 15 includes a screen for displaying maps and the current position and a speaker for outputting voices when performing the guidance.

The controller 16 is implemented by causing a central processing unit (CPU), a micro processing unit (MPU), an application specific integrated circuit (ASIC), a field programmable gate array (FPGA), or the like to execute various kinds of computer programs (for example, the travel direction estimating program) stored in a storage apparatus within the terminal apparatus 100 with a storage area of a RAM or the like as a work area, for example. In the example illustrated in FIG. 2, the controller 16 includes a guidance executing unit 17, a voice output unit 18, an image output unit 19, and a direction estimating unit 20 (hereinafter, may collectively be referred to as respective processing units 17 to 20). The direction estimating unit 20 includes a detector 21, an identifying unit 22, a determining unit 23, an estimating unit 24, and a calculating unit 25.

Connection relation among the respective processing units 17 to 20 that the controller 16 includes is not limited to the connection relation illustrated in FIG. 2 and may be another connection relation. The respective processing units 17 to 20 implement and execute functions and actions of guidance processing (e.g., FIG. 1) described below, and these are functional units arranged for the sake of description and do not necessarily match actual hardware components or software modules. In other words, the terminal apparatus 100 may implement and execute the guidance processing by any functional units so long as it can implement and execute the functions and actions of the following guidance processing.

### 3. Example of Effects in Guidance Processing

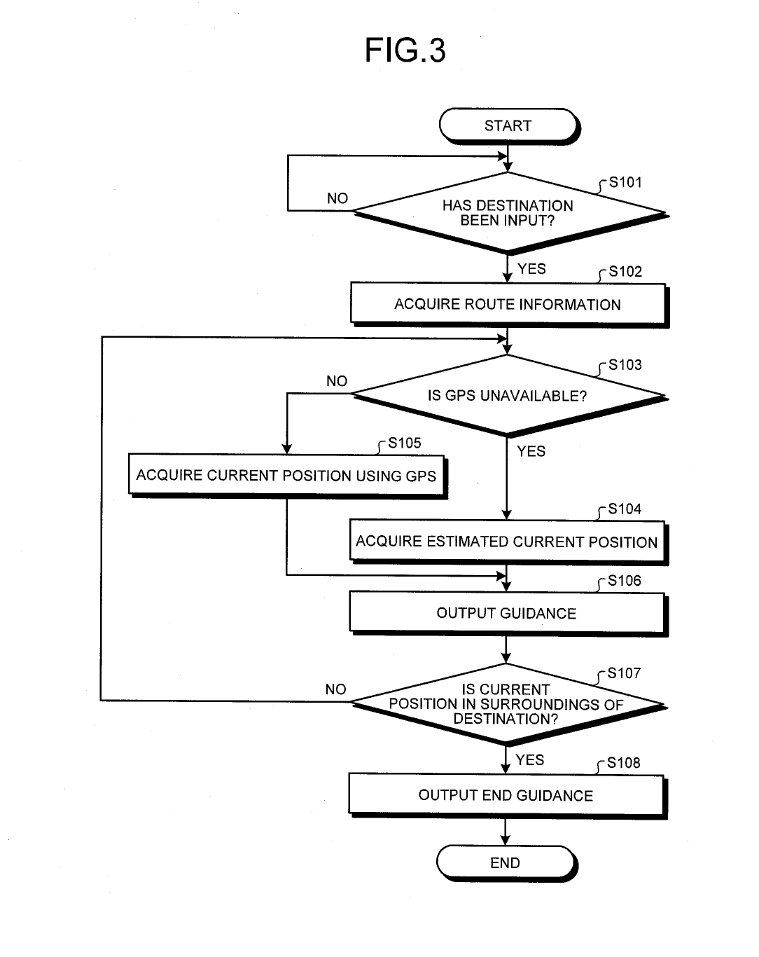

The following describes details of the guidance processing that the respective processing units 17 to 20 execute and implement with reference to the flowchart illustrated in FIG. 3. FIG. 3 is a flowchart of an example of a procedure of guidance processing that the terminal apparatus according to the embodiment executes.

First, the guidance executing unit 17 determines whether the destination has been input from the user (Step S101). If the destination has been input (Yes at Step S101), the guidance executing unit 17 acquires the route information from an external server (omitted to be illustrated) (Step S102). The guidance executing unit 17 then determines whether the GPS is available (Step S103).

If the GPS receiving antenna 14 cannot receive the signals from the satellites or if the number of satellites from which the signals have been able to be received is less than a certain threshold, for example, the guidance executing unit 17 determines that the GPS is unavailable (Yes at Step S103) and acquires the current position from the travel direction and the speed of the vehicle C10 estimated by the direction estimating unit 20 (Step S104). The guidance executing unit 17, with a site identified or estimated to be the current position from the previous GPS as a starting point, estimates a site when traveling in the travel direction estimated by the direction estimating unit 20 at the estimated speed to be a new current position, for example. Specific details of the estimation processing in which the direction estimating unit 20 estimates the travel direction and the speed of the vehicle C10 will be described below.

In contrast, if it is determined that the GPS is available (No at Step S103), the guidance executing unit 17 identifies the current position using the GPS (Step S105). The guidance executing unit 17 then controls the voice output unit 18 and the image output unit 19 to output the guidance using the current position using the GPS or the estimated current position (Step S106). The voice output unit 18 outputs voices indicating the current position, a direction in which the vehicle C10 is to travel, and the like from the output unit 15 in accordance with the control by the guidance executing unit 17, for example. The image output unit 19 outputs an image in which the current position and a map of its surroundings are superimposed with each other and images indicating a direction in which the vehicle C10 is to travel and the like from the output unit 15 in accordance with the control by the guidance executing unit 17.

Next, the guidance executing unit 17 determines whether the current position is in the surroundings of the destination (Step S107). If it is determined that the current position is in the surroundings of the destination (Yes at Step S107), the guidance executing unit 17 controls the voice output unit 18 and the image output unit 19 to output end guidance indicating the end of the guidance (Step S108) and ends the processing. In contrast, if it is determined that the current position is not in the surroundings of the destination (No at Step S107), the guidance executing unit 17 executes Step S103. If the destination has not been input (No at Step S101), the guidance executing unit 17 waits until it is input.

### 4. Example of Effects in Estimation Processing

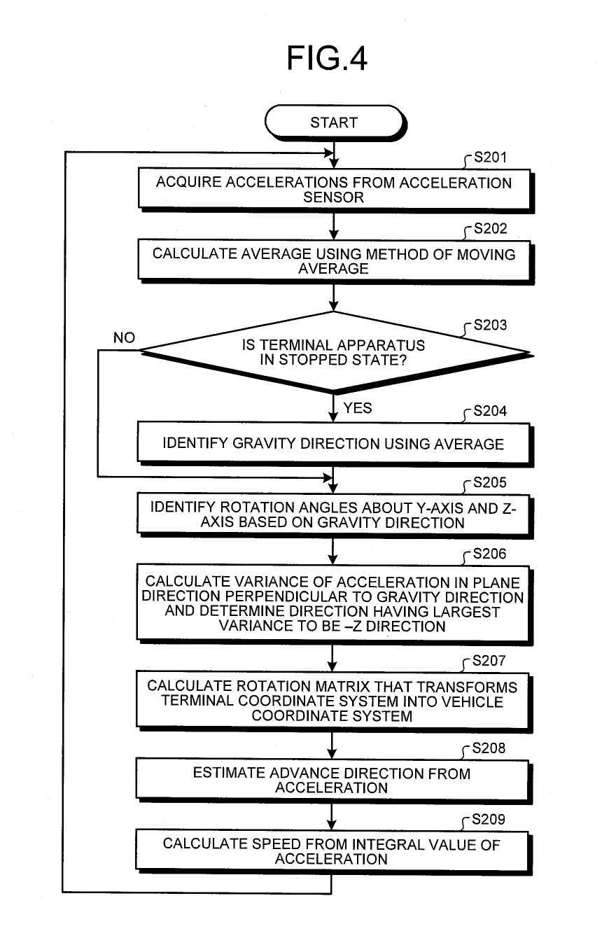

Next, the following describes details of the guidance processing that the detector 21, the identifying unit 22, the determining unit 23, the estimating unit 24, and the calculating unit 25 that the direction estimating unit 20 includes execute and implement with reference to the flowchart illustrated in FIG. 4. FIG. 4 is a flowchart of an example of a procedure of estimation processing that the terminal apparatus according to the embodiment executes.

First, the detector 21 acquires accelerations from the acceleration sensor 13 (Step S201). An acceleration value that the acceleration sensor 13 measures is considered to contain noise. Given this situation, the detector 21 calculates an average of the measured accelerations for the respective acceleration sensors 13a to 13c using a method of moving average as one kind of a low-pass filter (Step S202). The method of moving average is a technique that, when there are pieces of data successively measured, calculates an average of a plurality of pieces of data last measured.

Specifically, the detector 21 outputs an average of a plurality of acceleration values detected until a certain time has elapsed or an average of a certain number of acceleration values successively detected as a value of the average of the detected accelerations. The detector 21 determines an average of acceleration values that the acceleration sensor 13a has measured in a period from a time t−n to a time t to be an acceleration value that the acceleration sensor 13a has measured at the time t and determines an average of acceleration values that the acceleration sensor 13a has measured in a period from a time t−n+1 to a time t+1 to be an acceleration value that the acceleration sensor 13a has measured at the time t+1, for example.

Next, the determining unit 23 determines whether the terminal apparatus 100 is traveling based on features that the acceleration values have (Step S203). The determining unit 23 determines whether the terminal apparatus 100 is traveling using a support vector machine (SVM) that has been made to learn features that the acceleration values measured while the terminal apparatus 100 is traveling and while the terminal apparatus 100 is not traveling have, for example.

The support vector machine is a kind of a learning model that learns features that teacher data has (that is, a model generated by supervised learning). The SVM that the determining unit 23 uses is a learning model that, with stop data indicating accelerations in three-axis directions measured when a vehicle is stopped and travel data indicating acceleration in the three-axis directions measured while the vehicle is accelerating or traveling as teacher data, performs learning on feature amounts that the data has so as to be able to isolate the stop data and the travel data from each other with high precision, for example. The SVM learns features of an amplitude, a standard deviation, a frequency, an average, a maximum value, and a minimum value of values contained in the range of a certain time (e.g., 1 second) among the measured acceleration values for each of the respective axis directions, for example.

When newly measured accelerations in the three-axis directions are input, the SVM that has learned the features of the travel data and the stop data can identify whether the newly measured accelerations are accelerations measured while traveling or whether the newly measured accelerations are accelerations measured while being stopped based on features that the accelerations in the respective axis directions have with high precision. Given this situation, when the accelerations in the respective axis directions that the detector 21 detects are input to the SVM learned in travel, and when the SVM determines that the acceleration values are the accelerations measured while being stopped, the determining unit 23 determines that the vehicle C10 is being stopped.

In order to achieve accurate determination, the terminal apparatus 100 may use the SVM that has learned by teacher data measured by the terminal apparatus 100 itself or a terminal apparatus of the same type as the terminal apparatus 100. In order to achieve robust determination, the terminal apparatus 100 may use the SVM that has learned by teacher data measured by various kinds of terminal apparatuses including the terminal apparatus of the same type as the terminal apparatus 100.

The teacher data of the SVM may remain as a coordinate system of an apparatus that measures accelerations (e.g., the terminal coordinate system) or may be data transformed into a coordinate system of the vehicle (the vehicle coordinate system). In order to perform accurate measurement, the teacher data of the SVM is preferably accelerations measured by the terminal apparatus of the same type as the terminal apparatus 100 with an attitude similar to that when the terminal apparatus 100 performs the guidance.

Next, if the determining unit 23 determines that the terminal apparatus 100 is in a stopped state (Yes at Step S203), the identifying unit 22 identifies the gravity direction using the average of the accelerations (Step S204). As illustrated in section 1C of FIG. 1, the acceleration sensor 13 of the terminal apparatus 100 always detects not only the acceleration responsive to the acceleration and deceleration of the vehicle C10 but also a gravitational acceleration G acting on the terminal apparatus 100, for example. In this situation, considering the motion of the vehicle C10, it is considered that the acceleration that the terminal apparatus 100 measures owing to the acceleration and deceleration of the vehicle C10 almost cancels out when seen in a sufficient period.

Consequently, it is estimated that the average and the direction of the detected accelerations are nearly the same as the value and the direction of the gravitational acceleration G. Given this situation, the terminal apparatus 100 calculates the average of the measured accelerations and can thereby identify the direction of the gravitational acceleration G (hereinafter, referred to as a “gravity direction”) in the terminal coordinate system. The gravity direction in the terminal coordinate system matches the gravity direction in the vehicle coordinate system, that is, the −X-axis direction and serves as an indicator identifying the installation attitude of the terminal apparatus 100, and thus the travel direction of the vehicle C10.

Given this situation, the estimating unit 24 executes processing illustrated in Steps S205 to S208 illustrated in FIG. 4 and thereby estimates the travel direction based on the gravity direction identified by the identifying unit 22 from the detected accelerations. First, the estimating unit 24 identifies a rotation angle about the Y axis and a rotation angle about the Z axis from the estimated gravity direction (Step S205).

As illustrated in section 1D of FIG. 1, when origins of the terminal coordinate system and the vehicle coordinate system are superimposed with each other, and when the Y axis and the y axis match, how the terminal apparatus 100 is inclined toward the back side of the screen can be identified by an angle β between the x axis and the X axis about the Y axis, for example. When the Z axis and the z axis match, how the terminal apparatus 100 is inclined to left and right directions with the screen placed toward the near side can be identified by an angle γ between the y axis and the Y axis about the Z axis. A more general method of identification will be described with reference to numerical expressions in the following description.

The gravitational acceleration G is an force in the −X-axis direction. The magnitude of the gravitational acceleration G can be represented by a square root of the sum of squares of the accelerations in the respective axis directions in the terminal coordinate system. The estimating unit 24 can then calculate the angle β using a trigonometric function from the magnitude of the detected accelerations in the −x-axis direction and the magnitude of the gravitational acceleration G. Similarly, the estimating unit 24 can calculate the angle γ using a trigonometric function from the magnitude of the detected accelerations in the +y-axis direction and the magnitude of the gravitational acceleration G. Consequently, the estimating unit 24 can identify a YZ plane perpendicular to the identified gravity direction. If it is determined that the terminal apparatus 100 is not in a stopped state (No at Step S203), the estimating unit 24 may identify the YZ plane based on the gravity direction previously identified.

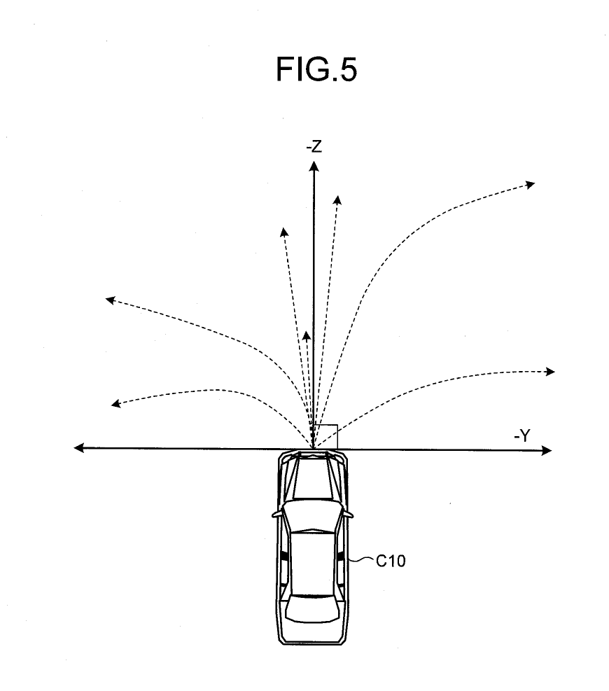

Next, the estimating unit 24 calculates variation, that is, variance of acceleration in a plane direction perpendicular to the identified gravity direction and determines a direction having the largest variation to be an travel direction of the vehicle C10, that is, the −Z-axis direction (Step S206). FIG. 5 is a diagram of an example of an acceleration occurring when a vehicle travels, for example. The YZ plane in the vehicle coordinate system is a plane perpendicular to the X-axis direction and can be divided into the Z-axis direction as the travel direction of the vehicle C10 and the Y-axis direction perpendicular to the Z-axis direction, for example. Considering the behavior of the vehicle C10, as illustrated by the dotted straight line in FIG. 5, it is estimated that an acceleration when the vehicle C10 shifts from a stopped state to a started state to travel straightforwardly is the strongest acceleration among accelerations occurring by the acceleration and deceleration of the vehicle C10. As illustrated by dotted curved lines, even when turning in the Y-axis direction, the vehicle C10 travels forward (in the −Z-axis direction).

Consequently, when the acceleration that the terminal apparatus 100 measures is projected onto the YZ plane, it is predicted that a direction in which the expanse of the measured acceleration becomes maximum, that is, a direction having the largest variance to be the front-and-rear direction of the vehicle C10, that is, the −Z-axis direction or the +Z-axis direction. Although it is undetermined which of the +Z-axis direction or the −Z-axis direction is the travel direction in this stage, a method for identifying the travel direction will be described with reference to expressions in the following description, and a description will be given with the −Z-axis direction as the direction having the largest variance in the following description.

As illustrated in section 1E of FIG. 1, the estimating unit 24 projects the measured acceleration onto the YZ plane perpendicular to the gravity direction and determines a direction P having the largest variation of accelerations to be the travel direction of the vehicle C10, that is, the −Z-axis direction, for example. As illustrated in FIG. 1F, when the direction P is estimated to be the −Z-axis direction, how the terminal apparatus 100 rotates about the up-and-down direction can be identified by the angle α between the Z axis and the z axis about the X-axis direction.

As illustrated in section 1G of FIG. 1, the terminal apparatus 100 then performs coordinate transformation on the measured acceleration using a rotation matrix that transforms the measured gravity direction into the X-axis direction of the vehicle coordinate system to calculate the travel direction and the speed. More specifically, as illustrated in FIG. 4, the estimating unit 24 identifies the angles α, β, and γ and then calculates the rotation matrix that transforms the terminal coordinate system into the vehicle coordinate system using the identified angles α, β, and γ (Step S207).

The estimating unit 24 generates the rotation matrix that rotates a vector of the terminal coordinate system by an angle −α about the x axis, rotates the vector by an angle −β about the y axis, and rotates the vector by an angle −γ about z axis, for example. The estimating unit 24 then transforms the detected accelerations of the terminal coordinate system into the detected accelerations of the vehicle coordinate system using the rotation matrix and estimates the travel direction of the vehicle C10 using the transformed acceleration (Step S208). In other words, the estimating unit 24 transforms the detected accelerations into the acceleration in the travel direction based on the gravity direction using the rotation matrix that causes the direction of the gravitational acceleration measured in the terminal coordinate system to match the X-axis direction in the vehicle coordinate system and analyzes the transformed acceleration to estimate the travel direction.

The estimating unit 24 estimates the travel direction of the vehicle C10 or a change in the travel direction using the accelerations on the YZ plane perpendicular to the X axis, that is, the acceleration in the Y-axis direction and the Z-axis direction, for example. More specifically, the estimating unit 24 determines that the vehicle C10 is accelerating if an acceleration in +Z-axis direction is measured and determines that the vehicle is decelerating if an acceleration in the −Z-axis direction is measured. The estimating unit 24 determines that the vehicle C10 has turned right if an acceleration in the +Y-axis direction perpendicular to the −Z-axis direction as the travel direction is measured and determines that the vehicle C10 has turned left if an acceleration in the −Y-axis direction is measured.

Next, the calculating unit 25 calculates a travel speed of the vehicle C10 using the transformed acceleration (Step S209). Specifically, with an average of a Z-axis component of the acceleration when the vehicle C10 is stopped as an origin (0), the calculating unit 25 determines an integral value of the Z-axis component of the acceleration to be the travel speed of the vehicle C10.

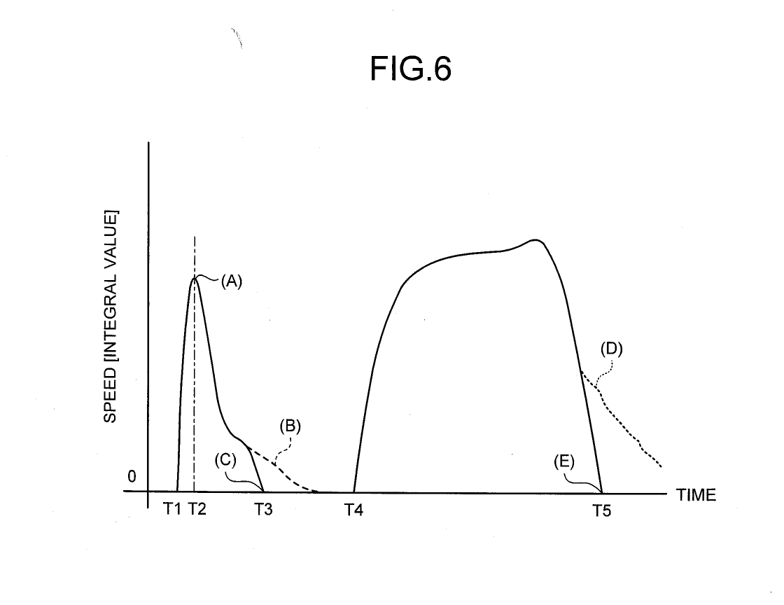

FIG. 6 is a diagram of an example of processing in which the terminal apparatus according to the embodiment calculates a speed of a vehicle, for example. The example illustrated in FIG. 6, with the value of speed in the −Z-axis direction as the vertical axis and with time as the horizontal axis, plots the progress of the speed. When the vehicle C10 accelerates forward during a period from a time T1 to a time T2, an acceleration in the +Z-axis direction is detected, and as illustrated in FIG. 6, the calculating unit 25 determines that the speed gradually increases, for example. When the vehicle C10 decelerates during a period from a time T2 a time T3, an acceleration in the −Z-axis direction is detected, and the speed of the vehicle C10 is gradually decreased with the speed indicated by (A) in FIG. 6 as the maximum speed.

Even when the vehicle C10 stops at the time T3, the integral value of the actually measured acceleration may be positive even after the time T3 as indicated by (B) in FIG. 6 depending on the setting of the origin, the accuracy of acceleration detectable by the terminal apparatus 100, or the like. When such an integral value is continuously used, an error is accumulated, and the error gradually increases.

Given this situation, if it is determined that the vehicle C10 is not traveling by the determining unit 23, the calculating unit 25 corrects the integral value to zero as indicated by (C) in FIG. 6. Similarly, if the vehicle accelerates at a time T4, the calculating unit 25 integrates the acceleration in the accelerating of the vehicle to calculate the speed. Even when the integral value of the actually measured acceleration makes a transition as indicated by (D) in FIG. 6, if it is determined that the vehicle C10 has stopped at a time T5, the calculating unit 25 then corrects the integral value to zero as indicated by (E) in FIG. 6.

### 5. Examples of Numerical Expressions in Estimation Processing

Next, the following describes an example of processing to calculate the rotation matrix by which the estimating unit 24 transforms the terminal coordinate system into the vehicle coordinate system with reference to expressions. The processing that the estimating unit 24 executes is not limited to the processing represented by the following expressions. The estimating unit 24 may perform the coordinate transformation from the terminal coordinate system into the vehicle coordinate system using an expression representing linear transformation, for example.

The respective axes of the terminal coordinate system are designated as xyz axes, whereas the respective axes of the vehicle coordinate system are designated as XYZ axes, for example. In that case, the processing to transform the vehicle coordinate system into the terminal coordinate system is represented by the following Expression (1). In Expression (1), a rotation angle about the x axis is designated as α, a rotation angle about the y axis is designated as β, a rotation angle about the z axis is designated as γ, a rotation matrix that performs coordinate transformation by rotation about the x axis is designated as Rₓ(α), a rotation matrix that performs coordinate transformation by rotation about the y axis is designated as R_{y}(β), and a rotation matrix that performs coordinate transformation by rotation about the z axis is designated as R_{z}(γ).

$$( \begin{matrix}x \\ y \\ z\end{matrix} ) = {R}_{z} ( γ ) {R}_{y} ( β ) {R}_{x} ( α ) ( \begin{matrix}X \\ Y \\ Z\end{matrix} ) \qquad ( 1 )$$

The rotation matrix Rₓ(α), the rotation matrix R_{y}(β), and the rotation matrix R_{z}(γ) (hereinafter, may collectively be referred to as “respective rotation matrices”) can be represented by the following Expressions (2) to (4):

$$\begin{matrix}{R}_{x} ( α ) = ( \begin{matrix}1 & 0 & 0 \\ 0 & cos α & - sin α \\ 0 & sin α & cos α\end{matrix} ) & ( 2 ) \\ {R}_{y} ( β ) = ( \begin{matrix}cos β & 0 & sin β \\ 0 & 1 & 0 \\ - sin β & 0 & cos β\end{matrix} ) & ( 3 ) \\ {R}_{z} ( γ ) = ( \begin{matrix}cos γ & - sin γ & 0 \\ sin γ & cos γ & 0 \\ 0 & 0 & 1\end{matrix} ) & ( 4 )\end{matrix}$$

The gravitational acceleration is the acceleration in the −X-axis direction and can be represented by the following Expression (5):

$$( \begin{matrix}X \\ Y \\ Z\end{matrix} ) = ( \begin{matrix}- G \\ 0 \\ 0\end{matrix} ) \qquad ( 5 )$$

Gravitational accelerations in the respective axis directions detected in the terminal coordinate system are referred to as aₓ, a_{y}, and a_{z}. In that case, the gravitational accelerations aₓ, a_{y}, and a_{z} in the terminal coordinate system are values obtained by transforming the gravitational acceleration represented by Expression (5) by the respective rotation matrices, and the following Expression (6) holds:

$$( \begin{matrix}{a}_{x} \\ {a}_{y} \\ {a}_{z}\end{matrix} ) = {R}_{z} ( γ ) {R}_{y} ( β ) {R}_{x} ( α ) ( \begin{matrix}- G \\ 0 \\ 0\end{matrix} ) = ( \begin{matrix}- G cos β cos γ \\ - G cos β sin γ \\ G sin β\end{matrix} ) \qquad ( 6 )$$

Consequently, Expression (7) is obtained from the value in the z-axis direction in Expression (6):

$$sin β = \frac{{a}_{z}}{G} \qquad ( 7 )$$

Considering the magnitude of the gravitational acceleration, Expression (8) holds, and Expression (9) is obtained from the values in the x-axis and y-axis directions in Expression (6). Consequently, the terminal apparatus 100 can identify the rotation angle β about the γ axis from Expression (7) and Expression (9):

$$\begin{matrix}{G}^{2} = {a}_{x}^{2} + {a}_{y}^{2} + {a}_{z}^{2} & ( 8 ) \\ cos β = \pm \sqrt{1 - {( \frac{{a}_{z}}{G} )}^{2}} = \pm \frac{\sqrt{{a}_{x}^{2} + {a}_{y}^{2}}}{G} & ( 9 )\end{matrix}$$

Among the values represented by Expression (9), the positive value is selected as a solution. Expression (10) and Expression (11) are then obtained from the values in the x-axis and y-axis values in Expression (6). Consequently, the terminal apparatus 100 can identify the rotation angle γ about the z axis from Expression (10) and Expression (11):

$$\begin{matrix}sin γ = - \frac{{a}_{y}}{\sqrt{{a}_{x}^{2} + {a}_{y}^{2}}} & ( 10 ) \\ cos γ = - \frac{{a}_{x}}{\sqrt{{a}_{x}^{2} + {a}_{y}^{2}}} & ( 11 )\end{matrix}$$

Processing to transform the terminal coordinate system into the vehicle coordinate system is inverse transformation of the coordinate transformation represented by Expression (1) and is represented by the following Expression (12):

$$( \begin{matrix}X \\ Y \\ Z\end{matrix} ) = {R}_{x} ( - α ) {R}_{y} ( - β ) {R}_{z} ( - γ ) ( \begin{matrix}x \\ y \\ z\end{matrix} ) \qquad ( 12 )$$

The values of β and γ can be calculated from the Expressions (7), (9), (10), and (11), and only the y axis and the z axis among acceleration samples aₓ, a_{y}, and a_{z} of the terminal coordinate system are rotated and are transformed into the vehicle coordinate system to obtain Expression (13):

$$( \begin{matrix}x \\ y \\ z\end{matrix} ) = {R}_{y} ( - β ) {R}_{z} ( - γ ) ( \begin{matrix}{a}_{x} \\ {a}_{y} \\ {a}_{z}\end{matrix} ) \qquad ( 13 )$$

Considered next is processing to project the acceleration samples onto the plane perpendicular to the gravitational acceleration G (that is, the YZ plane) and to determine the direction P having the largest variance. An acceleration sample in the y-axis direction is designated as y, an acceleration sample in the z-axis direction is designated as z, and components of the acceleration samples projected onto the YZ plane are designated as y′ and z′ to obtain Expression (14):

$$( \begin{matrix}{y}^{′} \\ {z}^{′}\end{matrix} ) = ( \begin{matrix}cos α & sin α \\ - sin α & cos α\end{matrix} ) ( \begin{matrix}y \\ z\end{matrix} ) \qquad ( 14 )$$

From Expression (14), z′ is extracted to obtain Expression (15):

z′=−y sin α+z cos α (15)

A direction in which an information amount of z′ becomes maximum, that is, the direction P having the largest variances is the travel direction of the vehicle C10. The sum of squares of a residual of z′ is then considered. When Z-axis components of N accelerations projected onto the YZ plane are designated as z₁′ to z_{N}′, the sum of squares of the residual is represented by the following Expression (16):

$$L = {\sum }_{i = 1}^{N} {( {z}_{i}^{′} - \overline{{z}^{′}} )}^{2} \qquad ( 16 )$$

In Expression (16), z′ attached with an overline is a value satisfying the following Expression (17):

$$\overline{{z}^{′}} = \frac{1}{N} {\sum }_{i = 1}^{N} {z}_{i}^{′} \qquad ( 17 )$$

Considering that partial differentiation of L by the angle α is zero, Expression (16) is modified into the following Expression (18). S_{y}, S_{z}, and S_{yz} in Expression (18) are values represented by the following Expressions (19) to (21):

$$\begin{matrix}\frac{\partial L}{\partial α} = 2 ( {S}_{y} - {S}_{z} ) sin αcosα - 2 {S}_{yz} ( {cos}^{2} α - {sin}^{2} α ) = 0 & ( 18 ) \\ {\sum }_{i = 1}^{N} {( {y}_{i} - \overline{y} )}^{2} = {S}_{y} & ( 19 ) \\ {\sum }_{i = 1}^{N} {( {z}_{i} - \overline{z} )}^{2} = {S}_{z} & ( 20 ) \\ {\sum }_{i = 1}^{N} ( {y}_{i} - \overline{y} ) ( {z}_{i} - \overline{z} ) = {S}_{yz} & ( 21 )\end{matrix}$$

Expression (18) is separated into a variable of α and a variable of coordinate, whereby Expression (22) can be derived:

$$\frac{{S}_{y} - {S}_{z}}{{S}_{yz}} = ( \frac{1}{tan α} - tan α ) \qquad ( 22 )$$

When the tangential function of α (tan α) is designated as t, and when the left side of Expression (22) is designated as s, Expression (22) can be represented by a quadratic function as represented by Expression (23), and t can be represented by Expression (24). In other words, the variable of α t can be represented by the variable of coordinate s.

$$\begin{matrix}{t}^{2} + st - 1 = 0 & ( 23 ) \\ t = \frac{- s \pm \sqrt{{s}^{2} + 4}}{2} & ( 24 )\end{matrix}$$

The sine function of α (sin α) and the cosine function of α (cos α) are represented by Expression (25) and Expression (26), respectively, from Expression (24):

$$\begin{matrix}cos α = \frac{1}{\sqrt{1 + {t}^{2}}} & ( 25 ) \\ sin α = \frac{1}{\sqrt{1 + {t}^{2}}} & ( 26 )\end{matrix}$$

When the values of Expression (24) are separated into the positive value and the negative value, they can be represented by the following Expression (27) and Expression (28), and the solution of t can be represented by either Expression (27) or Expression (28):

$$\begin{matrix}{t}_{p} = \frac{- s + \sqrt{{s}^{2} + 4}}{2} > 0 & ( 27 ) \\ {t}_{m} = \frac{- s - \sqrt{{s}^{2} + 4}}{2} < 0 & ( 28 )\end{matrix}$$

One of Expression (27) or Expression (28) can be a solution indicating a direction having the least variance. Given this situation, the second-order partial differentiation of L is considered. The second-order partial differentiation of L can be represented by Expression (29):

$$\begin{matrix}\frac{{\partial }^{2} L}{\partial {α}^{2}} = - 2 ( {S}_{z} - {S}_{x} ) ( {cos}^{2} α - {sin}^{2} α ) + 8 {S}_{yz} sin αcosα \\ = 2 \frac{tan α}{{S}_{yz}} {cos}^{2} α \{ {( {S}_{z} - {S}_{y} )}^{2} + 4 {S}_{yz}^{2} \}\end{matrix} \qquad ( 29 )$$

Considering the object that maximizes the information amount of z′, L is a convex function, and conditions satisfying Expression (30) are considered:

$$\frac{{\partial }^{2} L}{\partial {α}^{2}} < 0 \qquad ( 30 )$$

If S_{yz} is larger than zero, the value of t must be smaller than zero in order to satisfy Expression (30), and Expression (28) is the solution. In contrast, if S_{yz} is less than zero, the value of t must be larger than zero in order to satisfy Expression (30), and Expression (27) is the solution. Given this situation, the terminal apparatus 100 substitutes the value of t determined in accordance with the value of S_{yz} into Expression (25) and Expression (26) to calculate the value of the rotation angle α.

If the value of S_{yz} is zero, the second-order partial differentiation of L is represented by Expression (31). Consequently, if S_{z}−S_{y} is larger than zero, Expression (32) and Expression (33) hold, and if S_{z}−S_{y} is smaller than zero, Expression (34) and Expression (35) hold. The terminal apparatus 100 then calculates the value of α using Expression (32) and Expression (33) or Expression (34) and Expression (35) based on the value of S_{z}−S_{y}.

$$\begin{matrix}\frac{{\partial }^{2} L}{\partial {α}^{2}} = - 2 ( {S}_{z} - {S}_{y} ) ( {cos}^{2} α - {sin}^{2} α ) < 0 & ( 31 ) \\ cos α = 1 & ( 32 ) \\ sin α = 0 & ( 33 ) \\ cos α = 0 & ( 34 ) \\ sin α = 1 & ( 35 )\end{matrix}$$

When the value of α is calculated, it is unclear which direction of the Z axis is determined to be forward (the travel direction or the −Z-axis direction) by the vehicle C10. Given this situation, the terminal apparatus 100 identifies a forward direction of the vehicle C10 based on the sign of an acceleration measured when the vehicle C10 starts to travel or the sign of the integrated speed and determines the identified direction to be the −Z-axis direction. The terminal apparatus 100 determines a direction opposite to the direction of the acceleration measured when the vehicle C10 starts to travel to be the −Z-axis direction, for example. The terminal apparatus 100 identifies the −Z-axis direction so that the sign of the integrated speed will be positive.

Summing up the foregoing processing, the coordinate transformation that rotates the acceleration of the terminal coordinate system about the y axis and the z axis can be represented by the following Expression (36). The coordinate transformation that transforms the acceleration subjected to the coordinate transformation by Expression (36) into the acceleration subjected to the vehicle coordinate system by rotating the acceleration about the x axis is represented by the following Expression (37). Consequently, the terminal apparatus 100 transforms the terminal coordinate system into the vehicle coordinate system using Expression (36) and Expression (37).

$$\begin{matrix} ( \begin{matrix}{x}^{′} \\ {y}^{′} \\ {z}^{′}\end{matrix} ) = {R}_{y} ( - β ) {R}_{z} ( - γ ) ( \begin{matrix}x \\ y \\ z\end{matrix} ) = ( \begin{matrix}( x cos γ + y sin γ ) cos β - z sin β \\ - x sin γ + y cos γ \\ ( x cos γ + y sin γ ) sin β + z cos β\end{matrix} ) & ( 36 ) \\ ( \begin{matrix}x \\ y \\ z\end{matrix} ) = {R}_{x} ( - α ) ( \begin{matrix}{x}^{′} \\ {y}^{′} \\ {z}^{′}\end{matrix} ) = ( \begin{matrix}1 & 0 & 0 \\ 0 & cos α & sin α \\ 0 & - sin α & cos α\end{matrix} ) ( \begin{matrix}{x}^{′} \\ {y}^{′} \\ {z}^{′}\end{matrix} ) = ( \begin{matrix}{x}^{′} \\ {y}^{′} cos α + {z}^{′} sin α \\ - {y}^{′} sin α + {z}^{′} cos α\end{matrix} ) & ( 37 )\end{matrix}$$

### 6. Regarding Correction of Estimated Speed

When it is determined that the vehicle has stopped, the above terminal apparatus 100 corrects the integral value of the acceleration. However, embodiments are not limited thereto. The terminal apparatus 100 may correct the value of the acceleration or an appropriate coefficient for integrating the acceleration to obtain the integral value so that the integral value in a period from when it is determined that the vehicle C10 has stopped to when it is determined that the vehicle C10 has stopped again. The calculating unit 25 may correct the setting of the origin so that the integral value of the acceleration value measured in a period from the time T3 to the time T5 illustrated in FIG. 6 will be zero, for example.

The terminal apparatus 100 may correct the integral value of the acceleration using the GPS. The terminal apparatus 100 executes the above estimation processing, identifies the position of the terminal apparatus 100 based on the signals from the satellites, and calculates the travel speed of the terminal apparatus 100 from a fluctuation amount of the identified position, for example. The terminal apparatus 100 may correct the value of the detected accelerations (correct the value as the origin, for example) so that the estimated speed, that is, the integral value of the detected accelerations will have the same value as the calculated travel speed.

### 7. Regarding Correction of Travel Direction

The above terminal apparatus 100 determines the direction having large variance of acceleration to be the forward of the vehicle C10 (the −Z-axis direction). However, embodiments are not limited thereto. The terminal apparatus 100 may determine whether the vehicle C10 is traveling straightforwardly using the GPS, and if the vehicle is traveling straightforwardly, may set the direction of the acceleration detected during the situation to the Z-axis direction, for example. When identifying the progress of the current position of the vehicle C10 using the GPS and determining that the vehicle C10 is accelerating while traveling straightforwardly, the terminal apparatus 100 may calculate a rotation matrix expression that determines the direction of the detected accelerations on the YZ plane to be the rearward of the vehicle C10 (the +Z-axis direction) and transform the acceleration from the terminal coordinate system into the vehicle coordinate system using the rotation matrix expression.

### 8. Other Embodiments

The above embodiment is disclosed by way of example only, and the present invention includes the following examples and other embodiments. The functional configuration, a data structure, and the order and the details of the processing indicated in the flowcharts in the present application are disclosed by way of example only, and the presence or absence of the respective components, the arrangement of the respective components and the order of processing execution or the like, and the specific details can appropriately be altered. The above guidance processing and estimation processing can be implemented as an apparatus, a method, and a computer program in a terminal implemented by applications of smartphones or the like other than being implemented by the terminal apparatus 100 as exemplified in the above embodiment, for example.

It is general to implement the respective processing units 17 to 20 included in the terminal apparatus 100 by further respective independent apparatuses. The respective units 21 to 25 included in the direction estimating unit 20 may be implemented by respective independent apparatuses. Similarly, the configuration of the present invention can flexibly be altered such as implementing the respective units illustrated in the embodiment by calling an external platform or the like through an application program interface (API) or network computing (what is called cloud or the like). Furthermore, the respective components such as the units concerning the present invention may be implemented by another information processing mechanism such as a physical electronic circuit, not limited to an arithmetic control unit of a computer.

The terminal apparatus 100 may execute the above guidance processing on the condition that the terminal apparatus 100 and the distribution server communicable with the terminal apparatus 100 perform coordination with each other, for example. The distribution server includes the identifying unit 22, estimating unit 24, and the calculating unit 25 and estimates the travel direction and travel speed of the terminal apparatus 100 from the accelerations that the terminal apparatus 100 detects, for example. The distribution server may distribute the estimated travel direction and travel speed to the terminal apparatus 100 and cause the terminal apparatus 100 to execute the guidance for the user. The distribution server may execute the above estimation processing in place of the terminal apparatus 100 and transmit an execution result to the terminal apparatus 100 to cause the terminal apparatus 100 to execute the guidance processing.

The distribution server may include the determining unit 23 and determine whether the terminal apparatus 100 is traveling. When there are a plurality of terminal apparatuses that perform the guidance processing and the estimation processing in coordination with the distribution server, the distribution server may use different SVMs for each of the terminal apparatuses to determine whether the respective terminal apparatuses are traveling. The distribution server may collect pieces of position information that the respective terminal apparatuses acquire by the GPS, determine whether the respective terminal apparatuses are traveling from the collected pieced of position information, and perform the learning of the SVMs using determination results and values of accelerations collected from the respective terminal apparatuses.

### 9. Effects

As described above, the terminal apparatus 100 identifies the gravity direction using the average of the accelerations detected in the certain state. The terminal apparatus 100 estimates the travel direction based on the identified gravity direction from the detected accelerations. The terminal apparatus 100 thus identifies the gravity direction from the average of the measured accelerations and estimates the travel direction based on the identified gravity direction from the measured accelerations without performing any complicated processing. Consequently, the terminal apparatus 100 produces an effect of making it possible to easily identify the installation attitude and to estimate the travel direction of the vehicle C10 with high precision.

The terminal apparatus 100 identifies the gravity direction using the average of the accelerations detected in a state in which the terminal apparatus 100 is not traveling. Consequently, the terminal apparatus 100 can identify the gravity direction with high precision without performing any complicated processing, whereby the installation attitude can easily be identified, and the travel direction of the vehicle C10 can be estimated with high precision.

The terminal apparatus 100 transforms the detected accelerations into the acceleration in the travel direction based on the gravitational direction, that is, on the YZ plane perpendicular to the gravitational acceleration using the rotation matrix expression that causes the direction of the terminal coordinate system in which the gravitational acceleration is detected to match the certain axial direction of the vehicle coordinate system and estimates the travel direction using the transformed acceleration. Consequently, the terminal apparatus 100 can identify the direction in which the vehicle C10 travels from the detected accelerations without fixing the installation attitude of the terminal apparatus 100.

In a normal form, the vehicle C10 travels on the YZ plane, and the accelerations caused by the travel also occur on the YZ plane. Given this situation, the terminal apparatus 100 estimates the travel direction based on the YZ plane perpendicular to the gravity direction.

More specifically, the terminal apparatus 100 estimates the travel direction using the accelerations on the YZ plane perpendicular to the gravity direction among the detected accelerations. The terminal apparatus 100 detects a change in the travel direction of the terminal apparatus 100 based on the acceleration in the direction of the YZ plane perpendicular to the gravity direction and in the direction perpendicular to the travel direction. Consequently, the terminal apparatus 100 can estimate the travel direction and the travel speed of the vehicle C10 with high precision.

The terminal apparatus 100 calculates the variation of accelerations on the YZ plane perpendicular to the gravity direction and determines the direction in which the calculated variation becomes maximum, that is, the direction having the largest variance to be the −Z-axis direction. Consequently, the terminal apparatus 100 can identify the travel direction of the vehicle C10 easily and with high precision.

The terminal apparatus 100 calculates the average of the acceleration values detected until the certain time has elapsed or the average of the certain number of acceleration values successively detected and determines the calculated average to be the average of the detected accelerations. In other words, the terminal apparatus 100 smoothes the acceleration values that the acceleration sensor 13 detects using the method of moving average to reduce noise. Consequently, the terminal apparatus 100 can improve the accuracy of estimating the travel direction and the travel speed.

The terminal apparatus 100 determines whether the terminal apparatus 100, and thus the vehicle C10 is traveling based on the features that the detected acceleration values have and identifies the gravity direction using the average of the accelerations detected when it is determined that the terminal apparatus 100 is not traveling. Consequently, the terminal apparatus 100 can identify the gravity direction with high precision and can thereby improve the accuracy of estimating the travel direction and the travel speed.

The terminal apparatus 100 determines whether the terminal apparatus 100 is traveling using the SVM that has learned the features that the acceleration values measured while the terminal apparatus 100 is traveling and while the terminal apparatus 100 is not traveling have. Consequently, the terminal apparatus 100 can identify whether the terminal apparatus 100 is traveling with high precision.

The terminal apparatus 100 calculates the travel speed in the estimated travel direction. More specifically, the terminal apparatus 100 determines the integral value of the acceleration in the estimated travel direction to be the travel speed in that direction. Consequently, the terminal apparatus 100 can estimate the travel speed of the vehicle C10.

The terminal apparatus 100 corrects the integral value of the acceleration when the terminal apparatus 100 is not traveling. The terminal apparatus 100 corrects the detected acceleration value so that the integral value of the acceleration detected in the period from when the terminal apparatus 100 starts to travel to when the terminal apparatus 100 stops will be zero. The terminal apparatus 100 calculates the travel speed of the terminal apparatus 100 calculated based on the signals from the satellite and then corrects the detected acceleration value so that the integral value of the acceleration will be the calculated travel speed. As a result of these pieces of processing, the terminal apparatus 100 can improve the accuracy of estimating the travel speed.

Although some embodiments of the present application have been described in detail with reference to the accompanying drawings, these are by way of example only, and the present invention can be implemented by other forms in which various kinds of modifications and improvements have been made based on the knowledge of those skilled in the art in addition to the forms described in the disclosure of the invention.

The above “unit” can be read as “section”, “module”, “means” or “circuit.” The direction estimating unit can be read as a direction estimating means or a direction circuit.

An aspect of embodiments produces an effect of making it possible to easily identify an installation attitude and to estimate an travel direction of a vehicle with high precision.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An estimating apparatus comprising:
a detector that detects accelerations;
an identifying unit that identifies a gravity direction using an average of the accelerations that the detector detects in a certain state; and
an estimating unit that estimates a travel direction based on the gravity direction that the identifying unit identifies from the accelerations that the detector detects.

2. The estimating apparatus according to claim 1, wherein the identifying unit identifies the gravity direction using an average of the accelerations detected in which a terminal apparatus is not traveling.

3. The estimating apparatus according to claim 1, wherein the estimating unit, using a rotation expression that causes a direction in which the detector detects a gravitational acceleration to match a certain axial direction, transforms the acceleration that the detector detects into an acceleration in a travel direction based on a direction of the gravitational acceleration and estimates the travel direction using the transformed acceleration.

4. The estimating apparatus according to claim 1, wherein the estimating unit estimates a travel direction based on a plane perpendicular to the gravity direction.

5. The estimating apparatus according to claim 4, wherein the estimating unit estimates the travel direction using an acceleration on the plane perpendicular to the gravity direction among the accelerations that the detector detects.

6. The estimating apparatus according to claim 5, wherein the estimating unit detects a change in a travel direction of the terminal apparatus based on an acceleration in a direction on the plane perpendicular to the gravity direction and perpendicular to the travel direction.

7. The estimating apparatus according to claim 1, wherein the estimating unit calculates variation of accelerations on the plane perpendicular to the gravity direction and estimates a direction in which the calculated variation becomes maximum to be the travel direction.

8. The estimating apparatus according to claim 1, wherein the detector calculates an average of a plurality of acceleration values detected until a certain time has elapsed or an average of a certain number of acceleration values successively detected and outputs the calculated average as an average of the detected accelerations.

9. The estimating apparatus according to claim 1, further comprising;
a determining unit that determines whether the terminal apparatus is traveling based on features that acceleration values that the detector detects have, wherein the identifying unit identifies the gravity direction using the average of the accelerations that the detector detects when the determining unit determines that the terminal apparatus is not traveling.

10. The estimating apparatus according to claim 9, wherein the determining unit determines whether the terminal apparatus is traveling using a support vector machine that has learned features that acceleration values measured while the terminal apparatus is traveling and while the terminal apparatus is not traveling have.

11. The estimating apparatus according to claim 1, further comprising;
a calculating unit that calculates a travel speed in the travel direction that the estimating unit estimates.

12. The estimating apparatus according to claim 11, wherein the calculating unit determines an integral value of an acceleration in the travel direction that the estimating unit estimates to be a travel speed in the travel direction.

13. The estimating apparatus according to claim 12, wherein the calculating unit corrects the integral value of the acceleration to zero when the terminal apparatus is not traveling.

14. The estimating apparatus according to claim 11, wherein the calculating unit corrects the acceleration values that the detector detects so that an integral value of the acceleration detected in a period from when the terminal apparatus starts to travel to when the terminal apparatus stops becomes zero.

15. The estimating apparatus according to claim 11, wherein the calculating unit corrects the acceleration values that the detector detects so that an integral value of the acceleration and the travel speed of the terminal apparatus calculated based on signals from satellites matches.

16. A travel direction estimating method executed by a terminal apparatus, the method comprising:
detecting accelerations;
identifying a gravity direction using an average of accelerations detected in a certain state; and
estimating a travel direction based on the gravity direction identified at the identifying from the detected accelerations.

17. A non-transitory computer readable storage medium having stored therein a travel direction estimating program causing a computer to execute a process comprising:
detecting accelerations;
identifying a gravity direction using an average of accelerations detected in a certain state; and
estimating a travel direction based on the gravity direction identified at the identifying from the detected accelerations.
